(19) United States
(12) Patent Application Publication
(10) Pub. No.: US 2025/0308146 A1
(43) Pub. Date: Oct. 2, 2025

(54) TILE-BASED IMMEDIATE MODE RENDERER GRAPHICS PIPELINE WITH PIXEL CIRCUITRY BALANCING

(71) Applicant: ADVANCED MICRO DEVICES, INC., Santa Clara, CA (US)

(72) Inventors: Christopher J. Brennan, Boxborough, MA (US); Saurabh Sharma, Folsom, CA (US); Mark Fowler, Boxborough, MA (US)

(21) Appl. No.: 18/621,774

(22) Filed: Mar. 29, 2024

(51) Int. Cl. G06T 15/50; G06T 1/20; G06T 7/11; G06T 7/60

(52) U.S. Cl. CPC G06T 15/506; G06T 1/20; G06T 7/11; G06T 7/60

(57) ABSTRACT

An acceleration unit (AU) including instances of pixel circuitry first determines whether primitives in a frame to be rendered are at least partially visible in each tile of the frame. The AU then stores the geometry data of the primitives at least partially visible in each tile in a corresponding per-tile queue allocated to the tile and updates an available tile mask to indicate that the tile is available for rendering. Based on the available tile mask indicating that the first tile is available, a first instance of pixel circuitry uses the geometry data in the per-tile queue allocated to the first tile to attribute data of the primitives at least partially visible in the first tile to one or more buffers. The first instance of pixel circuitry then determines lighting data for the primitives based on the attribute data in the buffer.

### BACKGROUND

In a graphics processing system, three-dimensional scenes are rendered by graphics processing units (GPUs) for display on two-dimensional displays. To render such scenes, a GPU receives a command stream from an application indicating various primitives to be rendered. The GPU then renders these primitives according to a graphics pipeline that has various stages each including instructions to be performed by the GPU. For example, some graphics pipelines include a visibility pass wherein the GPU sorts each primitive to be rendered into a bin based on which tile of the scene the primitive is visible in. The GPU then renders the primitives in each bin sequentially. For example, the GPU renders the primitives in a first bin before rendering the primitives in a second bin. After rendering the primitives, the graphics processing system displays the rendered primitives as part of a three-dimensional scene displayed in a two-dimensional display.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured to implement a tile-based immediate mode renderer graphics pipeline with pixel circuitry balancing, in accordance with some embodiments.

FIG. 2 is a block diagram of an example processor core configured to implement at least a portion of a tile-based immediate mode renderer graphics pipeline with pixel circuitry balancing, in accordance with embodiments.

FIG. 3 is a timeline of an example tile-based immediate mode renderer graphics pipeline with pixel circuitry balancing, in accordance with embodiments.

FIG. 4 is a block diagram of an example operation for managing geometry and pixel states for a tile-based immediate-renderer graphics pipeline with pixel circuitry balancing, in accordance with embodiments.

FIG. 5 is an example method for implementing a tile-based immediate mode renderer graphics pipeline with pixel circuitry balancing, in accordance with embodiments.

### DETAILED DESCRIPTION

Systems and techniques disclosed herein are directed towards a processing system configured to implement a tile-based immediate mode renderer graphics pipeline with pixel circuitry balancing. Such a tile-based immediate mode renderer graphics pipeline is a graphics pipeline that includes first partitioning a frame to be rendered into two or more tiles. Further, the tile-based immediate mode renderer graphics pipeline includes determining which primitives of the frame to be rendered are at least partially visible in each tile and then sequentially rendering the primitives at least partially visible in each tile. For example, for a first tile of the frame, the tiled-based immediate-rendering graphics pipeline includes rendering (e.g., writing), to one or more per-pixel color buffers (PPC buffers), pixel attribute data (e.g., locations, colors) associated with the primitives at least partially visible in the first tile. The tile-based immediate mode renderer graphics pipeline then includes determining, based on the pixel attribute data in the PPC buffers, lighting values (e.g., intensity values) for the pixels of the primitives at least partially visible in the first tile. The resulting pixel data and lighting data are then stored in a frame buffer and this process is repeated for each tile of the frame.

To implement such a tile-based immediate mode renderer graphics pipeline with pixel circuitry balancing, a processing system includes an acceleration unit (AU) configured to receive a command stream from an application being executed by the processing system. The command stream, for example, includes data indicating the primitives to be rendered for each frame of a series of frames. As an example, for a first frame of a set of frames, the command stream includes data including one or more commands (e.g., draw commands, shading commands), geometry states, one or more pixel states, and data (e.g., vertices) indicating one or more primitives to be rendered in the frame. These geometry states include data (e.g. parameters) to initialize and dictate the tile-based immediate mode renderer graphics pipeline, geometry stages of the tile-based immediate mode renderer graphics pipeline, or both. Additionally, the pixel states include data (e.g., parameters) to initialize and dictate tile draw stages and tile lighting stages of the tile-based immediate mode renderer graphics pipeline. Such stages (e.g., geometry stages, tile draw stages, tile lighting stages) of the tile-based immediate mode renderer graphics pipeline each include sets of commands (e.g., draw commands, shading commands), geometry states, pixel states, or any combination thereof indicated in the command stream that use the same resources (e.g., same primitive data). Based on receiving the command stream, the AU first partitions the frame to be rendered into two or more tiles. Further, the AU allocates a corresponding per-tile queue to each tile of the frame. The AU then performs a geometry stage of the pipeline. During such a geometry stage, the AU performs a visibility pass to determine which primitives of the frame are at least partially visible in each tile of the frame. Based on a primitive being at least partially visible in a tile, the AU stores geometry data indicating vertex data, shading data, positioning data, or any combination thereof of the primitive in the per-tile queue allocated to the tile.

The AU then continues determining which tiles primitives of the frame are at least partially visible in until one or more certain commands in a command stream are received, a per-tile queue is at a threshold capacity (e.g., the per-tile queue stores an amount of data equal to or greater than a threshold amount), or both. After one or more certain commands in a command stream are received, a per-tile queue is at a threshold capacity (e.g., the per-tile queue stores an amount of data equal to or greater than a threshold amount), or both, the AU determines a first batch of primitives to be rendered. Such a first batch of primitives, for example, represents the primitives determined to be at least partially visible in one or more tiles of the frame before one or more certain commands in a command stream are received, a per-tile queue is at a threshold capacity, or both. After determining the first batch of primitives to be rendered, the AU continues storing the geometry data of each primitive of the batch of primitives in the per-tile queues of the tile in which the primitive is at least partially visible. While storing the geometry data of the primitives of the batch of primitives in the per-tile queues, AU determines whether a per-tile queue allocated to a tile includes geometry data for each primitive of the batch of primitives at least partially visible in the tile. Based on a per-tile queue allocated to a tile including geometry data for each primitive of the first batch of primitives at least partially visible in the tile, the AU is configured to update an available tile mask that includes data indicating which tiles are ready for rendering. That is to say, data indicating which per-tile queues store geometry data for primitives of a batch of primitives. Further, the AU continues determining which tiles primitives of the frame are at least partially visible in and forming one or more subsequent batches to be rendered until geometry data for each primitive of the frame has been stored in the per-queue tiles.

To render the primitives of the first batch of primitives, the AU includes instances of pixel circuitry each formed, for example, from a portion of a processor core of the AU. Each instance of pixel circuitry, for example, is configured to receive the same draw commands and pixel states of the command stream to each instance of pixel circuitry such that each instance of pixel circuitry is configured to perform the same set of commands using the same pixel states to implement one or more stages (e.g., groups of commands) of the tile-based immediate mode renderer graphics pipeline. To help balance the load between the instances of pixel circuitry while rendering the primitives of the batch of primitives, the instances of pixel circuitry are configured to render the primitives of the batch of primitives based on the available tile mask. For example, a first instance of pixel circuitry is configured to check which tiles the available tile mask indicates are available for rendering. Based on the available tile mask indicating that a first tile is available for rendering, the first instance of pixel circuitry initiates a tile draw stage for the first tile.

During the tile draw stage for the first tile, a first instance of pixel circuitry is configured to consume the per-tile queue associated with the first tile. Further, while the first instance of pixel circuitry consumes the per-tile queue, the AU is configured to update the first tile mask to indicate that the first tile is not available. The first instance of pixel circuitry then renders the primitives at least partially visible in the first tile into one or more per-pixel color buffers (PPC buffers) based on based on the obtained geometry data. That is to say, based on the geometry data stored in the per-tile queue allocated to the first tile, the first instance of pixel circuitry determines pixel attribute data indicating the position and color of the pixels of the primitives at least partially visible in the first tile. After the first instance of pixel circuitry writes such pixel attribute data associated with the first tile to the PPC buffers, the first instance of pixel circuitry then performs a tile lighting stage of the tile-based immediate mode renderer graphics pipeline for the first tile. During the tile lighting stage for the first tile, the first instance of pixel circuitry is configured to, based on the pixel attribute data associated with the first tile in the PPC buffers, determine lighting data (e.g., intensity data) for each pixel of the primitives of the batch of primitives at least partially visible in the first tile. The first instance of pixel circuitry then stores data representing the color and lighting for each pixel of the primitives of the batch of primitives at least partially visible in the first tile to a frame buffer for display.

Once the first instance of pixel circuitry stores such data in the frame buffer, the first instance of pixel circuitry then again checks the available tile mask to determine which other tiles are available for rendering in order to render the first batch of primitives. Based on the available tile mask indicating that another tile is available, the first instance of pixel circuitry consumes the per-tile queue associated with the available tile and begins to render the primitives of the first batch of primitives at least partially visible in the available tile to the PPC buffers. Further, concurrently with the first instance of pixel circuitry rendering the primitives of the batch of primitives at least partially visible in the first tile, each other instance of pixel circuitry of the AU is configured to the consume per-tile queues as indicated by the available tile mask. That is to say, each other instance of pixel circuitry of the AU is configured to check the available tile mask to determine which tiles are available for rendering. Based on the available tile mask indicating that a tile is available for rendering, the instance of pixel circuitry consumes a per-tile queue of a tile. After consuming a respective per-tile queue for a corresponding tile, each instance of pixel circuitry then performs the stages (e.g., groups of commands) of the tile-based immediate mode renderer graphics pipeline as indicated by the pixel states in the command stream to generate the data representing the color and lighting for each pixel of the primitives of the first batch at least partially visible in the corresponding tile. Once such data has been generated, each instance of pixel circuitry then consumes another per-tile queue of a tile indicated as ready for rendering by the available tile mask. Because the instances of pixel circuitry are configured to consume per-tile queues based on the available tile mask, the loads between instances of pixel circuitry are better balanced when compared to architectures where each instance of pixel circuitry is allocated to a corresponding per-tile queue. Due to this better balance between the instances of pixel circuitry, the processing time needed to render the frame is reduced and the processing efficiency of the processing system is increased.

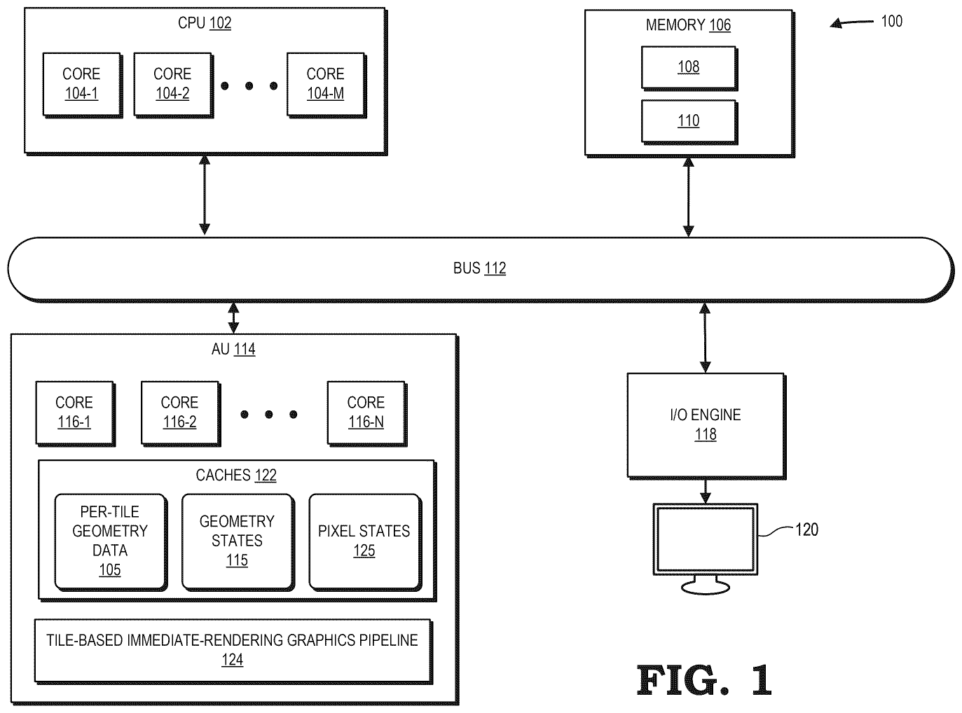

FIG. 1 is a block diagram of a processing system 100 configured to implement a tile-based immediate mode renderer graphics pipeline with pixel circuitry balancing, according to some implementations. The processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 112 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at acceleration unit (AU) 114. AU 114 includes, for example, vector processors, coprocessors, graphics processing units (GPUs), non-scalar processors, highly parallel processors, other multithreaded processing units, scalar processors, serial processors, programmable logic devices (e.g., field-programmable gate arrays) or any combination thereof. In embodiments, AU 114 renders scenes within a screen space (e.g., the space in which a scene is displayed) according to one or more applications 108 for presentation on a display 120. For example, AU 114 renders graphics objects (e.g., sets of primitives) of a scene in a screen space (e.g., display space) to be displayed to produce values of pixels that are provided to the display 120, which uses the pixel values to display a scene that represents the rendered graphics objects. To render these graphics objects, AU 114 implements a plurality of processor cores 116-1 to 116-N that execute instructions concurrently or in parallel. For example, AU 114 executes instructions from one or more graphics pipelines (e.g., tile-base immediate mode renderer graphics pipeline 124) using a plurality of processor cores 116 to render one or more graphics objects. A graphics pipeline, for example, includes one or more steps, stages, or instructions to be performed by AU 114 in order to render one or more graphics objects for a scene. As an example, a graphics pipeline includes data indicating an assembler stage, vertex shader stage, hull shader stage, tessellator stage, domain shader stage, geometry shader stage, binner stage, rasterizer stage, pixel shader stage, output merger stage, or any combination thereof to be performed by one or more processor cores 116 of AU 114 in order to render one or more graphics objects for a scene.

In embodiments, one or more processor cores 116 of AU 114 each operate as a compute unit configured to perform one or more operations for one or more instructions received by AU 114. These compute units each include one or more single instruction, multiple data (SIMD) units that perform the same operation on different data sets to produce one or more results. For example, AU 114 includes one or more processor cores 116 each functioning as a compute unit that includes one or more SIMD units to perform operations for one or more instructions from a graphics pipeline (e.g. tile-based immediate mode renderer graphics pipeline 124). To facilitate one or compute units performing operations for instructions from a graphics pipeline, AU 114 includes one or more command processors (not shown for clarity). Such command processors, for example, include circuitry configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents AU 114 as having three processor cores (116-1, 116-2, 116-N) representing an N number of cores, the number of processor cores 116 implemented in the AU 114 is a matter of design choice. As such, in other implementations, AU 114 can include any number of processor cores 116.

According to embodiments, one or more processor cores 116 of AU 114 each operating as one or more compute units are configured to store results (e.g., data resulting from the performance of one or more instructions, operations, or both) in one or more caches 122, memory 106, or both. Such caches 122, for example, include one or more caches 122 included in or otherwise connected to processor cores 116. As an example, in embodiments, caches 122 includes one or more caches shared between one or more processor cores 116 (e.g., shared caches), one or more caches private to (e.g., only accessibly by) a corresponding processor core 116 (e.g., private caches), or both. For example, according to some embodiments, caches 122 includes a cache hierarchy including one or more private caches, one or more shared caches, or both.

In embodiments, AU 114 is configured to render one or more graphics objects based on tile-based immediate mode renderer graphics pipeline 124. Tile-based immediate mode renderer graphics pipeline 124, for example, includes an immediate mode renderer in which an application 108 issues a command stream including data describing all the graphics objects (e.g., primitives) in a scene to be rendered for each frame to be rendered. For example, in embodiments, a command stream from an application 108 includes data indicating the position of vertices of one or more primitives to be rendered, one or more commands (e.g., draw commands, shader commands), one or more geometry states 115, and one or more pixel states 125. Such geometry states 115, for example, include data (e.g. parameters) to initialize and dictate the tile-based immediate mode renderer graphics pipeline 124, geometry stages of the tile-based immediate mode renderer graphics pipeline 124, or both. As an example, one or more first geometry states 115 indicate parameters, processes, and data used in initializing the tile-based immediate mode renderer graphics pipeline 124, and one or more second geometry states indicate parameters, processes, and data used in a geometry stage of tile-based immediate mode renderer graphics pipeline 124. Additionally, such pixel states 125 include data (e.g., parameters) to initialize and dictate tile draw stages and tile lighting stages of the tile-based immediate mode renderer graphics pipeline 124. For example, one or more first pixel states 125 indicate parameters, processes, and data used in the tile draw stages of the tile-based immediate mode renderer graphics pipeline 124, and one or more second pixel states 125 indicate parameters, processes, and data used in the tile lighting stages of the tile-based immediate mode renderer graphics pipeline 124. In embodiments, AU 114 is configured to store the geometry states 115 and pixel states 125 indicated in a command stream in one or more caches 122, memory 106, or both. Further, such geometry stages, tile draw stages, and tile lighting stages of tile-based immediate mode renderer graphics pipeline 124 each includes respective sets of commands (e.g., draw commands), geometry states, and pixel states that use the same resources (e.g., same primitive data).

In embodiments, AU 114 is configured to store the commands, geometry states 115, and pixel states 125 indicated in a command stream in one or more caches 122, memory 106, or both. As an example, AU 114 stores the commands and pixel states 125 indicated in the command stream in one or more pixel replay queues (not shown for clarity) coupled to one or more instances of pixel circuitry (not shown for clarity) each formed from at least a portion of a corresponding processor core 116 of AU 114. According to embodiments, AU 114 includes these instances of pixel circuitry to help implement one or more stages (e.g., groups of commands) of tile-based immediate mode renderer graphics pipeline 124. For example, the instances of pixel circuitry are each configured to perform commands indicated in the command stream based on the pixel states 125 indicated in the command stream. To this end, in embodiments, AU 114 is configured to provide the commands and pixel states 125 indicated in the command stream to each instance of pixel circuitry (e.g., to each processor core 116) via, for example, a pixel command replay queue. In this way, each instance of pixel circuitry is configured to perform the same commands based on the same pixel states 125. For example, based on these commands, each instance of pixel circuitry is configured to assemble, rasterize, and shade one or more primitives based on one or more corresponding pixel states so as to implement one or more stages (e.g., tile draw stages, tile lighting stages) of tile-based immediate mode renderer graphics pipeline 124.

According to embodiments, to implement the tile-based immediate mode renderer graphics pipeline 124, AU 114 first partitions a frame to be rendered into two or more tiles and then renders the graphics objects of the scene tile by tile. For example, based on one or more first geometry states 115 in a received command stream, AU 114 first partitions a frame to be rendered into two or more tiles (e.g., coarse tiles). Each tile, for example, includes a first number of pixels of the frame in a first direction (e.g., horizontal direction) and a second number of pixels of the frame in a second direction (e.g., vertical direction) perpendicular to the first direction indicated by the one or more first geometry states 115. According to some embodiments, a tile includes the same number of pixels in the first and second directions while in other embodiments the tile includes a different number of pixels in the first and second directions. After partitioning the frame to be rendered into two or more tiles, AU 114 then allocates a number of queues formed from at least a portion of caches 122, memory 106, or both to each tile of the frame such that each tile has a corresponding per-tile queue. As an example, AU 114 divides and allocates one or more per-shader engine queues formed from portions of caches 122 such that each tile of the frame is allocated a per-tile queue. Each per-tile queue, for example, includes one or more queues formed from at least a portion of caches 122, memory 106, or both. After AU 114 has allocated a per-tile queue to each tile of the frame, AU 114 begins a geometry stage of tile-based immediate mode renderer graphics pipeline 124 based on one or more second geometry states 115 of the command stream.

Such a geometry stage, for example, includes a visibility pass in which AU 114 determines which primitives (e.g., graphics objects) are to be rendered for each tile of the frame. For example, based on data indicating vertices of one or more primitives to be rendered in the command stream, AU 114 assembles (e.g., performs an assembly stage) and shades (e.g., performs one or more shaders) the one or more of the indicated primitives. As an example, AU 114 first assembles one or more primitives indicated in the command stream. For each assembled primitive, AU 114 then determines which tiles of the frame the primitive at least partially covers. Based on AU 114 determining that an assembled primitive is at least partially visible in a tile, AU 114 provides geometry data indicating vertex data, shading data, positioning data, or any combination thereof of the primitive to the per-tile queue associated with the tile. According to some embodiments, AU 114 continues to perform the visibility pass until a certain command (e.g., tile flush command) is received from in the command stream, one or more per-tile queues are at a predetermined capacity threshold (e.g., store a predetermined amount of data), or both. After a certain command (e.g., tile flush command) is received from in the command stream, one or more per-tile queues are at a predetermined capacity threshold (e.g., store a predetermined amount of data), or both, AU 114 then determines a first batch (e.g., group) of primitives to be rendered. For example, AU 114 determines a batch of primitives including the primitives for which a visibility determination was made before a certain command was received in the command stream, one or more per-tile queues are at a predetermined capacity threshold, or both. After AU 114 has determined the first batch of primitives to be rendered, AU 114 continues to perform the visibility pass so as to determine which tiles of the frame the remaining primitives of the frame are at least partially visible in and one or more subsequent batches of primitives to be rendered.

Further, after AU 114 has determined the first batch of primitives to be rendered, AU 114 continues to store geometry data of the primitives of the first batch of primitives in the per-tile queues. While storing such geometry data of the primitives of the first batch of primitives in the per-tile queues, AU 114 determines whether a per-tile queue allocated to a tile includes geometry data for each primitive of the first batch of primitives at least partially visible in the tile. Based on a per-tile queue allocated to a tile including geometry data for each primitive of the first batch of primitives at least partially visible in the tile, AU 114 is configured to update an available tile mask (not shown for clarity) that includes data indicating which tiles are ready for rendering (e.g., data indicating which per-tile queues store geometry data for primitives of a batch of primitives). Referring to the example embodiment presented in FIG. 1, the geometry data of primitives of a batch of primitives at least partially visible in a corresponding tile is represented in FIG. 1 as per-tile geometry data 105.

To render the first batch of primitives, the instances of pixel circuitry of AU 114 are each configured to render the primitive are each configured to check the available pixel mask. For example, a first instance of pixel circuitry is configured to check the available mask to determine which tiles are available for rendering. Based on the available tile mask indicating a first tile is available for rendering, the first instance of pixel circuitry is configured to render the primitives at least partially visible in the first tile to a PPC buffer (not shown for clarity) formed from caches 122, memory 106, or both based on one or more first pixel states 125 of the command stream. As an example, based on the available tile mask indicating a first tile is available for rendering perform the tile draw stage for the first tile, the first instance of pixel circuitry initiates a tile draw stage of tiled-based immediate mode renderer graphics pipeline 124 for the first tile. To perform the tile draw stage for the first tile, the first instance of pixel circuitry consumes the per-tile queue allocated to the first tile so as to obtain the per-tile geometry data 105 of the first tile. In embodiments, based on the first instance of pixel circuitry consuming the per-tile queue allocated to the first tile, AU 114 updates the available tile mask to indicate that the first tile is not available for rendering. After consuming the per-tile queue allocated to the first tile, the first instance of pixel circuitry then assembles, rasterizes, and shades the primitives of the batch of primitives at least partially visible in the first tile using the per-tile geometry data 105 and based on one or more first pixel states 125 to produce per-tile pixel attribute data that is stored in one or more PPC buffers and per-tile pixel depth data that is stored in a depth buffer (e.g., Z-buffer) formed from at least a portion of caches 122, memory 106, or both. Such per-tile pixel attribute data represents the attributes (e.g., color, position) of the pixels forming the primitives of the patch of primitives at least partially visible in the tile and such per-tile pixel depth data represents the depth of the pixels forming the primitives of the batch of primitives at least partially visible in the tile.

After completing a tile draw stage for a first tile, the first instance of pixel circuitry performs a tile lighting stage for the first tile. During such a tile lighting stage, the first instance of pixel circuitry performs one or more pixel-shading operations as indicated in one or more second pixel states 125 so as to determine lighting values (e.g., intensity values) that represent the direct and indirect lighting for each pixel forming primitives of the batch of primitives at least partially visible in the tile using the per-tile pixel attribute data in the PPC buffers. The first instance of pixel circuitry then stores pixel values representing the color and lighting (e.g., intensity) of each pixel forming primitives at least partially visible in the tile in a frame buffer formed from at least a portion of caches 122, memory 106, or both. In some embodiments, once the first instance of pixel circuitry has determined the lighting values for each pixel forming primitives at least partially visible in the first tile, the first instance of pixel circuitry discards the per-tile pixel attribute data stored in the PPC buffers associated with the tile. For example, based on one or more commands from an application 108, the first instance of pixel circuitry discards the per-tile pixel attribute data stored in the PPC buffers associated with the first tile after performing the commands included in a tile lighting stage for the tile. After completing the tile lighting stage for the first tile, discarding the per-tile pixel attribute data associated with the first tile, or both, the first instance of pixel circuitry again checks the available tile mask to determine if another tile is available for rendering. Based on the available tile mask indicating that another tile is available for rendering, the first instance of pixel circuitry then consumes the per-tile queue associated with the available tile and performs a tile draw stage and tile lighting stage for the available tile as indicated above with reference to the first tile.

Further in embodiments, while the first instance of pixel circuitry is performing a tile draw stage, tile lighting stage, or both of tile-based immediate mode renderer graphics pipeline 124 for the first tile, one or more other instances of pixel circuitry are each configured to check (e.g., configured to access) the available tile mask to determine if one or more other tiles are available for rendering. Based on a tile being available, an instance of pixel circuitry then consumes the per-tile queue associated with the available tile so as to obtain the per-tile geometry data 105 associated with the available tile. Using the per-tile geometry data 105, the instance of pixel circuitry then performs a tile draw stage and tile lighting stage for the available tile as indicated above with reference to the first tile. Additionally, after the instance of pixel circuitry has performed a tile lighting stage for the available tile, the instance of pixel circuitry again checks the available tile mask to determine if another tile is available. The instances of pixel circuitry then continue in this manner for until tile draw stages and tile lighting stages for each tile have been completed and each primitive of the batch of primitives have been rendered.

In this way, the instances of pixel circuitry are configured to perform stages (e.g., groups of commands) based on the available tile mask rather than predetermined assignments, helping to balance the load between the instances of pixel circuitry. Due to this balance between the instances of pixel circuitry, the processing time needed to render the frame is reduced and the processing efficiency of the processing system is increased when compared to processing systems having unbalanced loads between instances of pixel circuitry. Additionally, because each instance of pixel circuitry is configured to begin performing tile draw sages and tile lighting stages based on one or more available tile masks, a first instance of pixel circuitry is enabled to perform a different stage of tile-based immediate mode renderer graphics pipeline 124 for a first tile from a stage of tile-based immediate mode renderer graphics pipeline 124 performed by a second instance of pixel circuitry for a second tile. For example, according to some embodiments, while a first instance of pixel circuitry performs a tile lighting stage for the first tile, a second instance of pixel circuitry is configured to perform a tile draw stage for a second tile of the frame, a tile lighting stage for a second tile of the frame, or both. As another example, while a first instance of pixel circuitry performs commands (e.g., commands of a tile draw stage or tile lighting stage) for a first tile so as to render primitives in a first batch of primitives, a second instance of pixel circuitry performs commands (e.g., commands of a tile draw stage or tile lighting stage) for a second tile so as to render primitives in a second batch of primitives.

The processing system 100 also includes a central processing unit (CPU) 102 that is connected to the bus 112 and therefore communicates with the AU 114 and the memory 106 via the bus 112. The CPU 102 implements a plurality of processor cores 104-1 to 104-N that execute instructions concurrently or in parallel. In implementations, one or more of the processor cores 104 operate as SIMD units that perform the same operation on different data sets. For example, one or more processor cores 104 operate as SIMD units each having two or more lanes each configured to perform an operation (e.g., spatial test) of a wave. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. In some implementations, the CPU 102 and AU 114 have an equal number of processor cores 104, 116 while in other implementations, the CPU 102 and AU 114 have a different number of processor cores 104, 116. The processor cores 104 execute instructions such as program code 110 for one or more applications 108 stored in the memory 106 and the CPU 102 stores information in the memory 106 such as the results of the executed instructions. The CPU 102 is also able to initiate graphics processing by issuing a command stream from one or more application 108 to AU 114.

Processing system 100 also includes an input/output (I/O) engine 118 that includes hardware and software to handle input or output operations associated with the display 120, as well as other elements of the processing system 100 such as keyboards, mice, printers, external disks, and the like. The I/O engine 118 is coupled to the bus 112 so that the I/O engine 118 communicates with the memory 106, the AU 114, or the CPU 102.

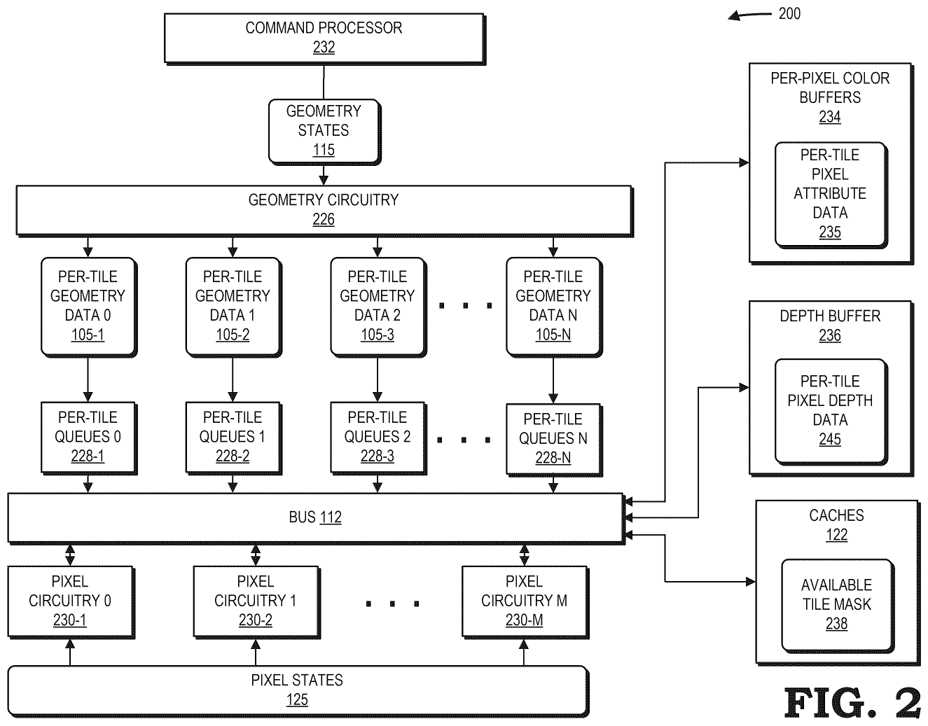

Referring now to FIG. 2, an example architecture 200 for an AU configured to implement at least a portion of a tile-based immediate mode renderer graphics pipeline 124 with pixel circuitry balancing is presented, in accordance with embodiments. In some embodiments, example architecture 200 is implemented within AU 114. According to embodiments, an AU implementing example architecture 200 is configured to perform at least a portion of tile-based immediate mode renderer graphics pipeline 124 by executing one or more instructions, operations, or both associated with tile-based immediate mode renderer graphics pipeline 124. To this end, example architecture 200 includes or is otherwise connected to one or more command processors 232. A command processor 232, for example, includes circuitry configured to receive a command stream from an application 108. Such a command stream, for example, includes one or more geometry states 115, pixel states 125, and data indicating one or more primitives to be rendered in a scene of a frame. Such geometry states 115, for example, include data (e.g. parameters) to initialize and dictate tile-based immediate mode renderer graphics pipeline 124, geometry stages of the tile-based immediate mode renderer graphics pipeline 124, or both. Additionally, such pixel states 125 include data (e.g., parameters) to initialize and dictate tile draw stages and tile lighting stages of the tile-based immediate mode renderer graphics pipeline 124.

In embodiments, one or more command processors 232 are configured to provide one or more draw commands and the pixel states 125 indicated in the command stream to each instance of pixel circuitry (230-1, 230-2, 230-M). For example, one or more command processors 232 each provide data indicating one or more draw commands and pixel states 125 of the command stream to one or more pixel command replay queues (not shown for clarity) which then provide the draw commands and pixel states 125 to each instance of pixel circuitry 230. These pixel states 125, for example, include data (e.g., parameters) to initialize and dictate tile draw stages and tile lighting stages of the tile-based immediate mode renderer graphics pipeline 124. For example, one or more first pixel states 125 include data to initialize and dictate the tile draw stages of tile-based immediate mode renderer graphics pipeline 124, and one or more second pixel states 125 include data to initial and dictate the tile lighting stages of tile-based immediate mode renderer graphics pipeline 124.

According to embodiments, based on one or more first geometry states 115 provided from command processor 232, an AU implementing example architecture 200 initializes tile-based immediate mode renderer graphics pipeline 124. To this end, the AU implementing example architecture 200 first partitions the frame to be rendered into a number of tiles indicated by one or more first geometry states 115. Each tile, for example, includes a number of pixels in a first direction and a number of pixels in a second direction as indicated by one or more first geometry states 115. After partitioning the frame into tiles, the AU implementing example architecture 200 then allocates a per-tile queue 228 to each tile as indicated by the one or more first geometry states 115. For example, the AU implementing example architecture 200 allocates a first per-tile queue 0 228-1 to a first tile, a second per-tile queue 1 228-2 to a second tile, a third per-tile queue 2 228-3 to a third tile, and an Nth per-tile queue N 228-N to an Nth tile. Such per-tile queues 228 are each formed from at least a portion of caches 122, memory 106, or both and include one or more queues, for example, first in, first out (FIFO) queues. Though the example embodiment presented in FIG. 2 shows an example architecture 200 with four per-tile queues 228 representing an N number of per-tile queues 228 that support an N number of tiles of a frame, in other embodiments, example architecture 200 can include any number of per-tile queues 228 supporting any number of tiles of a frame. Further, in some embodiments, each per-tile queue 228 is formed from one or more per-shader engine queues of the AU implementing example architecture 200.

Based on one or more second geometry states 115 of the command stream, the AU implementing example architecture 200 then performs a geometry stage (e.g., visibility pass) to determine which primitives to be rendered for the frame are at least partially visible in each tile of the frame. To this end, example architecture 200 includes or is otherwise connected to a geometry circuitry 226 configured to implement one or more primitive assemblers, shaders (e.g., geometry shaders), or both so as to assemble and shade one or more primitives based on one or more second geometry states 115. As an example, based on one or more second geometry states 115 and data indicating the primitives to be rendered for the frame, geometry circuitry 226 assembles and shades one or more of the indicated primitives. Once geometry circuitry 226 has assembled and shaded the indicated primitives, geometry circuitry 226 then, for each assembled primitive, determines which tile the primitive is at least partially visible in. Based on an assembled primitive being at least partially visible in a tile, geometry circuitry 226 provides geometry data representing the vertex data, shading data, positioning data, or any combination of the primitive to the per-tile queue 228 allocated to the tile. In embodiments, geometry circuitry 226 is configured to perform the visibility pass until a certain command (e.g., tile flush command) is received from in the command stream, per-tile queues 228 are at a predetermined capacity threshold (e.g., store a predetermined amount of data), or both. Once a certain command (e.g., tile flush command) is received from in the command stream, one or more per-tile queues 228 are at a predetermined capacity threshold (e.g., store a predetermined amount of data), or both, geometry circuitry 226 forms a first batch of primitives to be rendered represented by the geometry data stored in the per-tile queues 228. Further, after forming the first batch of primitives to be rendered, geometry circuitry 226 continues the visibility pass and continues to store geometry data of subsequent primitives of the frame in the per-tile queues 228. Based on subsequent certain commands in the command stream, per-tile queues 228 being at a predetermined capacity threshold (e.g., store a predetermined amount of data), or both, geometry circuitry 226 also forms additional batches of primitives to be rendered.

In embodiments, after forming the first batch of primitives to be rendered, geometry circuitry 226 continues to store geometry data of the primitives of the first batch of primitives in the per-tile queues 228 until geometry data for each primitive of the first batch of primitives has been stored. Once geometry circuitry 226 has stored the geometry data representing each primitive of a batch of primitives at least partially visible in a tile to a corresponding per-tile queue 228, such stored data is represented in FIG. 2 as per-tile geometry data 105. Such per-tile geometry data (105-1, 105-2, 105-3, 105-N) each represents the vertex data, shading data, positioning data, or any combination of primitives in a batch of primitives at least partially visible within a corresponding tile. According to embodiments, based on geometry circuitry 226 storing the geometry data (e.g., per-tile geometry data 105) of each primitives of a batch of primitives for a tile in a corresponding per-tile queue 228, geometry circuitry 226 is configured to update available tile mask 238 to indicate that the tile is available for rendering. The available tile mask 238, for example, is stored in one or more caches 122 and includes data indicating which tiles of the frame to be rendered are available for a next stage (e.g., tile draw stage) of tile-based immediate mode renderer graphics pipeline 124. That is to say, data indicating which tiles are available for rendering.

To render the primitives in a batch of primitives, example architecture 200 includes a plurality of instances of pixel circuitry 230 each configured to assemble, rasterize, and shade primitives at least partially visible in a tile based on the per-tile geometry data 105 associated with the tile and one or more pixel states 125. For example, to render the primitives in a batch of primitives in a first tile of the frame, a first instance of pixel circuitry 0 230-1 is configured to first check (e.g., configured to access) available tile mask 238 to determine which tiles are available for a tile draw stage. Based on the available tile mask 238 indicating that a tile (e.g., a first tile) is available, the first instance of pixel circuitry 0 230-1 consumes the per-tile queue 228 allocated to the tile (e.g., per-tile queue 0 228-1) so as to obtain the per-tile geometry data 105 (e.g., per-tile geometry data 0 105-1) associated with the tile. After obtaining the per-tile geometry data 105 associated with the tile, the first instance of pixel circuitry 0 230-1 then renders the primitives indicated in the per-tile geometry data 105 as a batch (e.g., coarse batch) to one or more PPC buffers 234 based on one or more first pixel states 125. That is to say, the first instance of pixel circuitry 0 230-1 assembles, rasterizes, and shades the primitives indicated in the per-tile geometry data 105 based on one or more first pixel states 125 to produce per-tile pixel attribute data 235 that is stored in the PPC buffers 234. Further, based on assembling, rasterizing, and shading these primitives based on per-tile geometry data 105, the first instance of pixel circuitry 0 230-1 produces per-tile pixel depth data 245 that is stored in a Z-buffer 236. The PPC buffers 234 and Z-buffer 236, for example, each one or more buffers formed from at least corresponding portions of caches 122, memory 106, or both. As an example, PPC buffers 234 include one or more buffers configured to store data indicating the color and position of each pixel of a frame and Z-buffer 236 includes one or more buffers configured to store data indicating the depth values of each pixel of the frame. In embodiments, the per-tile pixel attribute data 235 stored in the PPC buffers 234 after performing a tile draw stage for the first tile represents, for example, the attributes (e.g., color, position) of the pixels forming the primitives of the batch of primitives at least partially visible in the first tile and the per-tile pixel depth data 245 stored in the Z-buffer 236 represents the depth of the pixels forming the primitives of the batch of primitives at least partially visible in the first tile.

After the first instance of pixel circuitry 0 230-1 has completed the tile draw phase for a tile (e.g., first tile) and based on one or more second pixel states 125, pixel circuitry 230 performs a lighting stage of the tile-based immediate mode renderer graphics pipeline 124 for the tile. For example, as indicated by the one or more second pixel states 125, the first instance of pixel circuitry 0 230-1 performs one or more pixel-shading operations using the per-tile pixel attribute data 235 associated with the tile so as to determine lighting values (e.g., intensity values) that represent the direct and indirect lighting for each pixel forming primitives at least partially visible in the first tile. The first instance of pixel circuitry 0 230-1 then stores the pixel values representing the color and lighting (e.g., intensity) of each pixel forming primitives at least partially visible in the tile in a frame buffer (not shown for clarity) formed from at least a portion of caches 122, memory 106, or both. After completing the tile lighting stage for the tile, the first instance of pixel circuitry 0 230-1 then checks the available tile mask 238 to determine if another tile is ready for a tile draw stage. That is to say, the first instance of pixel circuitry 0 230-1 determines whether the available tile mask 238 indicates another tile is available for rendering. Based on the available tile mask 238 indicating that another tile is available, the first instance of pixel circuitry 0 230-1 consumes the per-tile queue 228 associated with the tile and performs a tile draw stage and tile lighting stage for the tile.

Further in embodiments, while the first instance of pixel circuitry 0 230-1 is performing a tile draw stage or tile lighting stage of tile-based immediate mode renderer graphics pipeline 124 for a first tile, one or more other instances of pixel circuitry 230 are configured to check the available tile mask 238 to determine if one or more other tiles are available. Based on a tile being available for rendering, an instance of pixel circuitry 230 then consumes the per-tile queue 228 associated with the available tile so as to obtain the per-tile geometry data 105 associated with the available tile. The instance of pixel circuitry 230 then uses the per-tile geometry data 105 to perform a tile draw stage and tile lighting for the available tile. After performing the tile lighting stage for the tile, the instance of pixel circuitry 230-1 again checks the available tile mask to determine if another tile is available. Each instance of pixel circuitry 230 then continues in this manner until each primitive in a batch of primitives has been rendered each primitive of the frame has been rendered, or both. Though the example embodiment presented in FIG. 2 shows example architecture 200 as including three instances of pixel circuitry 230 represented an M number of instances of pixel circuitry 230, in other embodiments, example architecture 200 can include any number of instances of pixel circuitry 230.

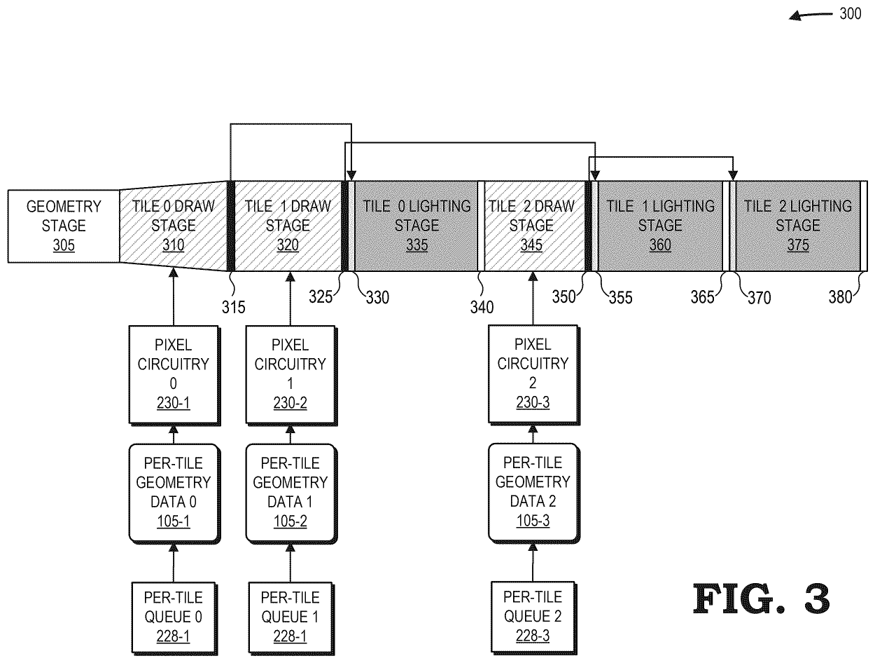

Referring now to FIG. 3, an example tile-based immediate mode renderer graphics pipeline 300 including pixel circuitry balancing is presented, in accordance with embodiments. According to embodiments, example tile-based immediate mode renderer graphics pipeline 300 is implemented by AU 114 based on one or more commands from an application 108. For example, in embodiments, after example tile-based immediate mode renderer graphics pipeline 300 is initialized, example tile-based immediate mode renderer graphics pipeline 300 first includes AU 114 performing a geometry stage 305 based on one or more first geometry states 115. During the geometry stage 305, AU 114 is configured to determine which primitives of a batch of primitives to be rendered for a frame are at least partially visible in each tile of the frame. To this end, AU 114 assembles and shades one or more primitives to be rendered in the frame based on one or more first geometry states 115. For each assembled primitive, AU 114 then determines in which tiles the assembled primitive is at least partially visible (e.g., present). In response to AU 114 determining that an assembled primitive is at least partially visible in a tile, AU 114 provides geometry data (e.g., per-tile geometry data 105) indicating vertex data, shading data, positioning data, or any combination of the primitive to the per-tile queue 228 allocated to the tile.

According to some embodiments, during the geometry stage 305, AU 114 is configured to assemble primitives and determine which tiles the assembled primitives are at least partially visible in until a certain command (e.g., tile flush command) is received in the command stream, one or more per-tile queues 228 are at a predetermined capacity threshold (e.g., store a predetermined amount of data), or both. After the certain command is received in the command stream, one or more per-tile queues 228 are at a predetermined capacity threshold, or both, AU 114 forms a batch of primitives to be rendered that are represented by the per-tile geometry data 105 stored in the per-tile queues 228. That is to say, AU 114 is configured to form a batch of primitives to be rendered based on a certain command being received in the command stream, one or more per-tile queues 228 being at a predetermined capacity, or both. As an example, based on a per-tile queue 228 becoming full, AU 114 is configured to render a batch of primitives (e.g., the primitives represented by the per-tile geometry data in the per-tile queues 228) by performing a tile draw stage and tile lighting stage for each tile of the frame. As another example, after initiating a visibility pass and based on the command stream received by AU 114 indicating a flush tile command, AU 114 is configured to render a batch of primitives by performing a tile draw stage and tile lighting stage for each tile of the frame.

After forming a batch of primitives to be rendered, AU 114 continues to store the geometry data of the primitives of the batch of primitives in respective per-tile queues 228. Based on storing geometry data for each primitive of the batch of primitives for a tile in a corresponding per-tile queue 228, AU 114 updates available tile mask 238 to indicate that the tile is available for rendering. Additionally, after forming the batch of primitives to be rendered, AU 114 continues geometry stage 305 until geometry data has been determined and stored for each primitive of the frame in each tile of the frame. Further, AU 114 is configured to form one or more subsequent batches of primitives to be rendered based on a certain command being received in the command stream, one or more per-tile queues 228 being at a predetermined capacity, or both.

To render primitives in a batch of primitives, one or more instances of pixel circuitry 230 are configured to check available tile mask 238 to determine whether one or more tiles are available for a tile draw stage. For example, for a first tile of the frame, a first instance of pixel circuitry 0 230-1 checks available tile mask 238 to determine whether the first tile is available. Based on the available tile mask 238 indicating that the first tile is available, the first instance of pixel circuitry 0 230-1 begins a tile 0 draw stage 310 based on one or more first pixel states 125. During the tile 0 draw stage 310, the first instance of pixel circuitry 0 230-1 the primitives of the batch of primitives at least partially visible in the first frame into the PPC buffers 234 based on the per-tile geometry data 105 stored in the per-tile queue 228 associated with the first tile. For example, referring to the embodiment presented in FIG. 3, the first instance of pixel circuitry 0 230-1 renders the primitives of the batch of primitives at least partially visible in the first frame based on per-tile geometry data 0 105-1 from per-tile queue 0 228-1. In embodiments, during the tile 0 draw stage 310, the first instance of pixel circuitry 0 230-1 first assembles, rasterizes, and shades the primitives indicated in per-tile geometry data 0 105-1 based on one or more first pixel states 125 so as to produce per-tile pixel attribute data 235 that is stored in one or more PPC buffers 234 and per-tile pixel depth data 245 that is stored in a Z-buffer 236. According to some embodiments, tile 0 draw stage 310 includes the first instance of pixel circuitry 0 230-1 performing a scissor operation based on the size of the tile. For example, based on one or more first pixel states, the first instance of pixel circuitry 0 230-1 discards per-tile pixel attribute data 235 and per-tile pixel depth data 245 associated with any pixels outside of a box based on the size and position of the tile (e.g., a box having the same size and position as the tile).

After the first instance of pixel circuitry 0 230-1 has performed tile 0 draw stage 310, example tile-based immediate mode renderer graphics pipeline 300 includes the first instance of pixel circuitry 0 230-1 performing a release command 315 based on one or more commands indicated in the command stream. During the release command 315, the first instance of pixel circuitry 0 230-1 releases the per-tile pixel attribute data 235 associated with the first tile in the PPC buffers 234 such that the first instance of pixel circuitry 0 230-1 is enabled to perform a lighting stage (e.g., tile 0 lighting stage 335) for the first tile. For example, the first instance of pixel circuitry 0 230-1 flushes one or more PPC buffers 234 so as to release the per-tile pixel attribute data 235 associated with the first tile. Concurrently with the first instance of pixel circuitry 0 230-1 performing the release command 315, example tile-based immediate mode renderer graphics pipeline 300 includes a second instance of pixel circuitry 1 230-2 checking available tile mask 238 to determine whether another tile (e.g., second tile) is available. Based on the available tile mask 238 indicating that the second tile is available, the second instance of pixel circuitry 1 230-2 performs tile 1 draw stage 320 based on one or more first pixel states 125 (e.g., the first pixel states that were provided to each instance of pixel circuitry 230). During the tile 1 draw stage 320, the second instance of pixel circuitry 1 230-2 renders the primitives of the batch of primitives at least partially visible in a second tile of the frame into the PPC buffers 234 based on the per-tile geometry data 105 stored in the per-tile queue 228 associated with the second tile. As an example, referring to the embodiment presented in FIG. 3, the second instance of pixel circuitry 1 230-2 renders the primitives at least partially visible in the second tile based on per-tile geometry data 1 105-2 from per-tile queue 1 228-2. According to embodiments, during the tile 1 draw stage 320, the second instance of pixel circuitry 1 230-2 renders the primitives indicated in per-tile geometry data 1 105-2 so as to produce per-tile pixel attribute data 235 associated with the second tile that is stored in one or more PPC buffers 234 and per-tile pixel depth data 245 associated with the second tile that is stored in a Z-buffer 236. In some embodiments, tile 1 draw stage 320 also includes the second instance of pixel circuitry 1 230-2 performing one or more scissor operations based on the size of the tile and one or more first pixel states 125. Once the second instance of pixel circuitry 1 230-2 has performed tile 1 draw stage 320, example tile-based immediate mode renderer graphics pipeline 300 includes the second instance of pixel circuitry 1 230-2 performing a release command 325 based on one or more commands in the command stream (e.g., based on one or more commands from an application 108). During the release command 325, the second instance of pixel circuitry 1 230-2 releases the per-tile pixel attribute data 235 associated with the second tile from the PPC buffers 234 such that the second instance of pixel circuitry 1 230-2 is enabled to perform a lighting stage (e.g., tile 1 lighting stage 360) for the second tile.

After release command 325, example tile-based immediate mode renderer graphics pipeline 300 includes the first instance of pixel circuitry 0 230-1 performing acquire command 330 based on one or more commands of the command stream. During the acquire command 330, the first instance of pixel circuitry 0 230-1 acquires the per-tile pixel attribute data 235 associated with the first tile that was released from the PPC buffers 234 (e.g., based on release command 315). In response to the first instance of pixel circuitry 0 230-1 acquiring the per-tile pixel attribute data 235 associated with the first tile, the first instance of pixel circuitry 0 230-1 then performs tile 0 lighting stage 335 based on one or more second pixel states. During tile 0 lighting stage 335, the first instance of pixel circuitry 0 230-1 determines lighting values (e.g., intensity values) that represent the direct and indirect lighting for each pixel forming primitives of the batch of primitives at least partially visible in the first tile based on the per-tile pixel attribute data 235 associated with the first tile. For example, based on the released per-tile pixel attribute data 235 associated with the first tile, the first instance of pixel circuitry 0 230-1 performs one or more shading operations (e.g., fragment shading operations), lighting operations, or both according to one or more second pixel states 125 to determine the lighting values for each pixel forming primitives of the batch of primitives at least partially visible in the first tile. AU 114 then stores pixel values representing the color and lighting (e.g., intensity) of each pixel forming primitives of the batch of primitives at least partially visible in the first tile in a frame buffer. Additionally, after the first instance of pixel circuitry 0 230-1 performs tile 0 lighting stage 335, example tile-based immediate mode renderer graphics pipeline 300 includes the first instance of pixel circuitry 0 230-1 performing discard command 340 based on one or more commands in the command stream. The discard command 340, for example, includes the first instance of pixel circuitry 0 230-1 discarding the per-tile pixel attribute data 235 associated with the first tile. For example, the first instance of pixel circuitry 0 230-1 removes the per-tile pixel attribute data 235 associated with the first tile from one or more PPC buffers 234 so as to create free entries in the PPC buffers 234.

After discard command 340, example tile-based immediate mode renderer graphics pipeline 300 includes a third instance of pixel circuitry 2 230-3 checking available tile mask 238 to determine is another tile (e.g., third tile) is available. Based on available tile mask 238 indicating that a third tile is available, the third instance of pixel circuitry 2 230-3 performs tile 2 draw stage 345 based on the first pixel state 125. During the tile 2 draw stage 375, the third instance of pixel circuitry 2 230-3 renders primitives of the batch of primitives at least partially visible in a third tile of the frame to the PPC buffers 234. For example, the third instance of pixel circuitry 2 230-3 renders the primitives indicated in per-tile geometry data 2 105-3 so as to produce per-tile pixel attribute data 235 associated with the third tile that is stored in one or more PPC buffers 234 and per-tile pixel depth data 245 associated with the third tile that is stored in a Z-buffer 236. According to some embodiments, tile 2 draw stage 345 also includes the third instance of pixel circuitry 2 230-3 performing one or more scissor operations based on the size of the tile as indicated by one or more first pixel states 125. Once the third instance of pixel circuitry 2 230-3 has performed tile 2 draw stage 345, example tile-based immediate mode renderer graphics pipeline 300 includes the third instance of pixel circuitry 2 230-3 performing a release command 350 based on one or more commands in the command stream. During the release command 350, the third instance of pixel circuitry 2 230-3 releases the per-tile pixel attribute data 235 associated with the third tile in the PPC buffers 234 such that the third instance of pixel circuitry 2 230-3 is enabled to perform a lighting stage (e.g., tile 2 lighting stage 375) for the third tile.

Within example tile-based immediate mode renderer graphics pipeline 300, after release command 350, the second instance of pixel circuitry 1 230-2 performs attain command 355 based on one or more commands in the command stream during which the second instance of pixel circuitry 1 230-2 acquires the per-tile pixel attribute data 235 associated with the second tile that was released from the PPC buffers 234 (e.g., based on release command 325). In response to the second instance of pixel circuitry 1 230-2 acquiring the per-tile pixel attribute data 235 associated with the second tile, the second instance of pixel circuitry 1 230-2 then performs tile 1 lighting stage 360 based on one or more second pixel states 125. To perform tile 1 lighting stage 360, the second instance of pixel circuitry 1 230-2 performs, based on the released per-tile pixel attribute data 235 associated with the second tile, one or more shading operations (e.g., fragment shading operations), lighting operations, or both as indicated in one or more second pixel states 125 to determine lighting values (e.g., intensity values) that represent the direct and indirect lighting for each pixel forming primitives of the batch of primitives at least partially visible in the second tile. The second instance of pixel circuitry 1 230-2 then stores pixel values representing the color and lighting (e.g., intensity) of each pixel forming primitives of the batch of primitives at least partially visible in the second tile in the frame buffer. Further, after the second instance of pixel circuitry 1 230-2 performs tile 1 lighting stage 360, example tile-based immediate mode renderer graphics pipeline 300 includes the second instance of pixel circuitry 1 230-2 performing discard command 365 based on one or more commands in the command stream during which the second instance of pixel circuitry 1 230-2 discards the per-tile pixel attribute data 235 associated with the second tile from the PPC buffers 234.

After discard command 365, the third instance of pixel circuitry 2 230-3 performs attain command 370 based on one or more commands of the command stream during which the third instance of pixel circuitry 2 230-3 acquires the per-tile pixel attribute data 235 associated with the third tile that was released from the PPC buffers 234 (e.g., based on release command 350). Once the third instance of pixel circuitry 2 230-3 has acquired the per-tile pixel attribute data 235 associated with the third tile, the third instance of pixel circuitry 2 230-3 performs tile 2 lighting stage 375 based on one or more second pixel states 125. To this end, the third instance of pixel circuitry 2 230-3 performs, based on the released per-tile pixel attribute data 235 associated with the third tile, one or more shading operations (e.g., fragment shading operations), lighting operations, or both to determine lighting values (e.g., intensity values) that represent the direct and indirect lighting for each pixel forming primitives at least partially visible in the third tile. The third instance of pixel circuitry 2 230-3 then stores pixel values representing the color and lighting (e.g., intensity) of each pixel forming primitives of the batch of primitives at least partially visible in the third tile in the frame buffer. Additionally, after the third instance of pixel circuitry 2 230-3 performs tile 1 lighting stage 360, example tile-based immediate mode renderer graphics pipeline includes the third instance of pixel circuitry 2 230-3 discard command 380 based on one or more commands in the command stream during which the third instance of pixel circuitry 2 230-3 discards the per-tile pixel attribute data 235 associated with the third tile from the PPC buffers 234. Though the example tile-based immediate mode renderer graphics pipeline 300 presented in FIG. 3 shows respective instances of pixel circuitry 230 as performing a respective tile draw stage (310, 320, 345) and tile lighting stage (335, 360, 375) for three tiles of a frame, in other embodiments, the example tile-based immediate mode renderer graphics pipeline 300 includes the respective instances of pixel circuitry 230 each performing tile draw stages and tile lighting stages for any number of tiles of a frame.

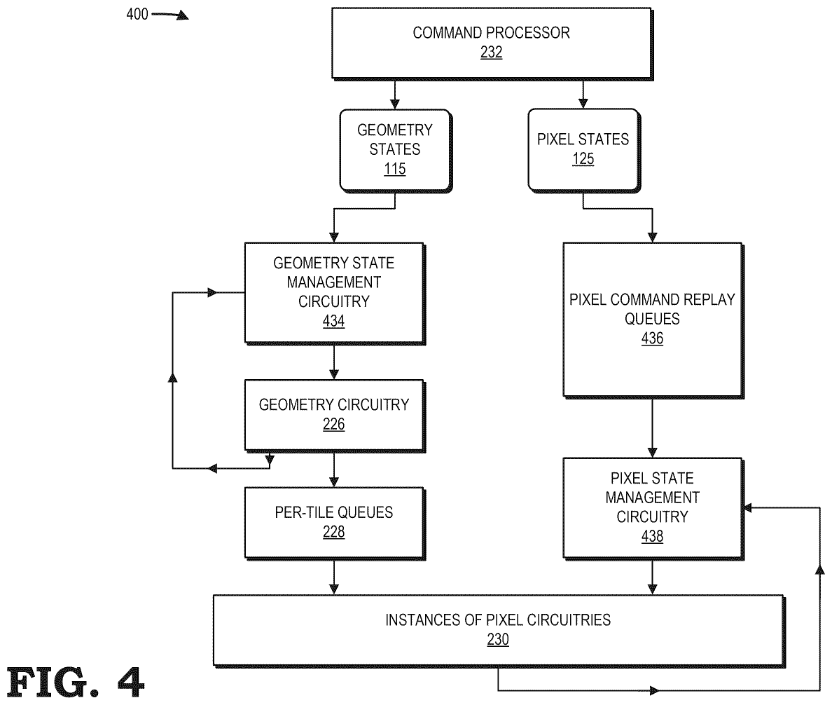

Referring now to FIG. 4, an example operation 400 for managing geometry and pixel states for a tile-based immediate-render graphics pipeline is presented, in accordance with some embodiments. In embodiments, example operation 400 is performed by AU 114 while implementing tile-based immediate mode renderer graphics pipeline 124. According to embodiments, example operation 400 first includes a command processor 232 receiving a command stream from, for example, CPU 102 that indicates one or more geometry states 115 and one or more pixel states 125 (e.g., first pixel states, second pixel states) for a scene to be rendered in a frame. Based on the received command stream, command processor 232 provides data indicating the geometry states 115 to a geometry state management circuitry 434. Such geometry state management circuitry 434, for example, is configured to store data indicating the geometry states 115 in one or more queues. For example, geometry state management circuitry 434 stores data indicating the geometry states 115 in the received command stream in one or more FIFO queues. Geometry state management circuitry 434 then passes the stored data indicating the geometry states 115 to geometry circuitry 226 so as to initiate and perform one or more stages of tile-based immediate mode renderer graphics pipeline 124. For example, geometry state management circuitry 434 passes data indicating one or more first geometry states 115 to geometry circuitry 226 so as to induce geometry circuitry 226 to initialize tile-based immediate mode renderer graphics pipeline 124. As another example, geometry state management circuitry 434 passes data indicating one or more second geometry states 115 to geometry circuitry 226 so as to induce geometry circuitry 226 to perform a geometry stage (e.g., geometry stage 305) that includes a visibility pass. As geometry circuitry 226 performs such a geometry stage, geometry circuitry 226 stores geometry data (e.g. per-tile geometry data 105) for each tile in a corresponding per-tile queue 228 allocated to the tile.

Additionally, in embodiments, based on the received command stream, example operation 400 includes command processor 232 provides data indicating one or more draw commands and the pixel states 125 to one or more pixel command replay queues 436. Such pixel command replay queues 436, for example, include one or more FIFO queues formed from at least a portion of caches 122, memory 106, or both. According to embodiments, such pixel command replay queues 436 are configured to provide the pixel states 125 stored in the pixel command replay queues 436 in the order in which they were received by the pixel command replay queues 436 to pixel state management circuitry 438 one or more times (e.g., configured to provide the pixel states 125 stored in the pixel command replay queues 436 in the order in which they were received multiple times). Based on the pixel states 125 received from the pixel command replay queues 436, pixel state management circuitry 438 is configured to induce one or more instances of pixel circuitry 230 to initiate and perform tile draw stages (e.g., tile draw stages 310, 320, 345) based on one or more first pixel states 125 and tile lighting stages (e.g., tile lighting stages 335, 360, 375) based on one or more second pixel states. According to some embodiments, pixel state management circuitry 438 includes a corresponding instance of pixel state management circuitry 438 for each instance of pixel circuitry 230. In such embodiments, an instance of pixel state management circuitry 438 is configured to induce a corresponding instance of pixel circuitry 230 to perform a certain stage of tile-based immediate mode renderer graphics pipeline 124 by passing a respective pixel state 125 to the corresponding instance of pixel circuitry 230.

As an example, pixel state management circuitry 438 passes one or more first pixel states 125 from pixel command replay queues 436 to a first instance of pixel circuitry 0 230-1 so as to induce the first instance of pixel circuitry 0 230-1 to perform a tile draw stage for a first tile of the frame. Based on the one or more first pixel states 125, the first instance of pixel circuitry 0 230-1 then performs the tile draw stage so as to produce per-tile pixel attribute data 235 for the first tile. Once the first instance of pixel circuitry 0 230-1 has completed the tile draw stage, the first instance of pixel circuitry 0 230-1 then sends data to pixel state management circuitry 438 indicating that the tile draw stage has been completed. Pixel state management circuitry 438 then provides one or more second pixel states 125 from the pixel command replay queues 436 to the first instance of pixel circuitry 0 230-1 so as to induce the first instance of pixel circuitry 0 230-1 to perform a tile lighting stage. Additionally, in embodiments, pixel state management circuitry 438 is configured to compare a pixel state 125 to be issued by pixel state management circuitry 438 to a current pixel state 125 received by a corresponding instance of pixel circuitry 230. That is to say, configured to compare a pixel state 125 to be issued to a most recently issued pixel state 125 to a corresponding instance of pixel circuitry 230. Based on the comparison indicating that the pixel state 125 to be issued is the same as the pixel state 125 that was most recently issued to a corresponding instance of pixel circuitry 230, pixel state management circuitry 438 filters out the pixel state 125 to be issued and does not provide it to the corresponding instance of pixel circuitry 230.

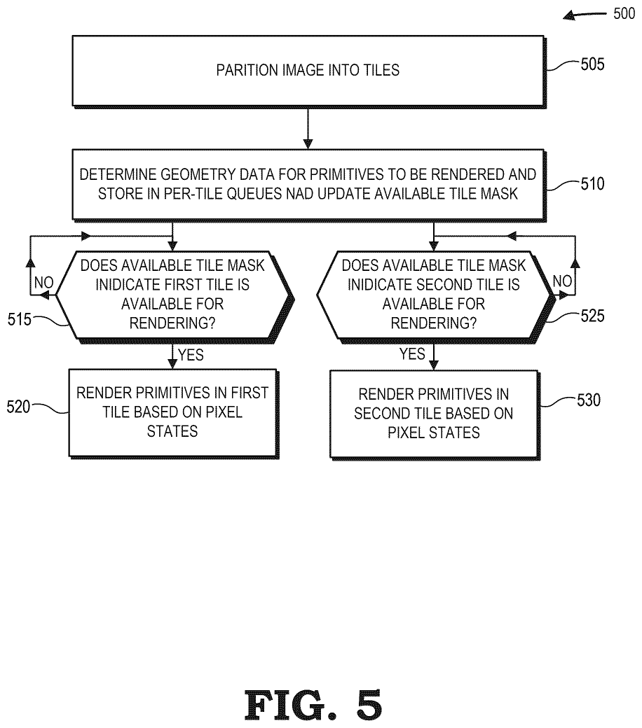

Referring now to FIG. 5, an example method 500 for performing a tile-based immediate mode renderer graphics pipeline with pixel circuitry balancing is presented, in accordance with embodiments. In embodiments, example method 500 is implemented by at least a portion of AU 114 (e.g., one or more processor cores 116 of AU 114). In embodiments, example method 500 first includes, at block 505, AU 114 receiving a command stream from CPU 102 indicating one or more draw commands, geometry states 115, and pixel states 125. Based on receiving such a command stream, AU 114 partitions a frame to be rendered into two or more tiles. Each tile, for example, includes a first number of pixels of the frame in a first direction and a second number of pixels of the frame in a second direction. Further, at block 505, AU 114 allocates a corresponding per-tile queue 228 to each tile of the frame. At block 510, example method 500 includes AU 114 determining per-tile geometry data 105 for each tile of the frame. To this end, AU 114 performs one or more assembly operations, shading operations (e.g., geometry shading operations), or both based on the geometry states 115 indicated in the command stream to produce one or more assembled primitives. For each assembled primitive, AU 114 then performs a visibility pass to determine which tiles the assembled primitive is at least partially in. Based on a primitive being at least partially within a tile, AU 114 stores geometry data (e.g., per-tile geometry data 105) indicating vertex data, shading data, positioning data, or any combination associated with the primitive in a per-tile queue 228 allocated to the tile.

In embodiments, still referring to block 510, based on a certain command (e.g., tile flush command) being received from the command stream, a per-tile queue 228 being at a threshold capacity, or both, AU 114 determines a first batch of primitives to be rendered (e.g., primitives that were assembled before the certain command was received, a per-tile queue 228 being at a threshold capacity, or both). After determining the first batch of primitives to be rendered, AU 114 continues to store geometry data of the primitives of the batch of primitives in corresponding per-tile queues. Based on a per-tile queue storing geometry data for each primitive of the batch of primitives for a corresponding tile, AU 114 updates available tile mask 238 to indicate that the tile is available for rendering.

At block 515, a first instance of pixel circuitry 0 230-1 of AU 114 checks available tile mask 238 to determine whether the first tile is available for rendering. In some embodiments, the first instance of pixel circuitry 0 230-1 is configured to check the available tile mask 238 concurrently with AU 114 performing the operations indicated at block 510. Based on the available tile mask 238 not indicating any tile is available for rendering, the first instance of pixel circuitry 0 230-1 repeats block 515 and again checks the available tile mask 238. Further, based on the available tile mask 238 indicating that the first tile is available for rendering, the first instance of pixel circuitry 0 230-1, at block 520, begins to render the primitives of a batch of primitives in the first tile. To this end, the first instance of pixel circuitry 0 230-1 renders the primitives at least partially visible in the first tile into the PPC buffers 234 based on the per-tile geometry data 105 stored in the per-tile queue 228 associated with the first tile. That is to say, the first instance of pixel circuitry 0 230-1, based on one or more first pixel states 125, assembles, rasterizes, and shades the primitives indicated in per-tile geometry data 105 associated with the first tile so as to produce per-tile pixel attribute data 235 associated with the first tile that is stored in one or more PPC buffers 234 and per-tile pixel depth data 245 associated with the first tile that is stored in a Z-buffer 236. In some embodiments, at block 520, the first instance of pixel circuitry 0 230-1 performs one or more scissor operations.

After rendering the primitives of the batch of primitives in the first tile to the one or more PPC buffers 234 and still referring to block 520, the first instance of pixel circuitry 0 230-1, based on one or more second pixel states 125, determines lighting values (e.g., intensity values) that represent the direct and indirect lighting for each pixel forming primitives at least partially visible in the first tile based on the released per-tile pixel attribute data 235 associated with the first tile. As an example, based on per-tile pixel attribute data 235 associated with the first tile, the first instance of pixel circuitry 0 230-1 performs one or more shading operations (e.g., fragment shading operations), lighting operations, or both to determine the lighting values for each pixel forming primitives at least partially visible in the first tile. The first instance of pixel circuitry 0 230-1 then stores pixel values representing the color and lighting (e.g., intensity) of each pixel forming primitives at least partially visible in the first tile in a frame buffer.

Concurrently with the first instance of pixel circuitry 0 230-1 performing operations indicated in block 520, a second instance of pixel circuitry 1 230-2 is configured to, at block 525, check the available tile mask 238 to determine if a tile is available for rendering. Based on the available tile mask 238 not indicating that any tile is available for rendering, the second instance of pixel circuitry 1 230-2 again checks the available tile mask 238 and repeats block 525. Based on the available tile mask 238 indicates that a second tile is available for rendering, the second instance of pixel circuitry 1 230-2, at block 530, renders the primitives at least partially visible in the second tile into the PPC buffers 234 based on the per-tile geometry data 105 stored in the per-tile queue 228 associated with the second tile and one or more first pixel states 125. As an example, the second instance of pixel circuitry 1 230-2 assembles, rasterizes, and shades the primitives indicated in per-tile geometry data 105 associated with the second tile so as to produce per-tile pixel attribute data 235 associated with the second tile that is stored in one or more PPC buffers 234 and per-tile pixel depth data 245 associated with the first frame that is stored in a Z-buffer 236. In some embodiments, at block 520, the second instance of pixel circuitry 1 230-2 performs one or more scissor operations.

After the second instance of pixel circuitry 1 230-2 has written the per-tile pixel attribute data 235 associated with the second frame to the PPC buffers 234, the second instance of pixel circuitry 1 230-2, based on one or more second pixel states, determines lighting values (e.g., intensity values) that represent the direct and indirect lighting for each pixel forming primitives at least partially visible in the second tile based on the per-tile pixel attribute data 235 associated with the second tile. The second instance of pixel circuitry 1 230-2 then stores pixel values representing the color and lighting (e.g., intensity) of each pixel forming primitives at least partially visible in the second tile in a frame buffer.

In some embodiments, the apparatus and techniques described above are implemented in a system including one or more integrated circuit (IC) devices (also referred to as integrated circuit packages or microchips), such as the AU described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design shown herein, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An acceleration unit (AU), comprising:
a plurality of per-tile queues each allocated to a tile of a plurality of tiles of a frame to be rendered; and
a first instance of pixel circuitry configured to:
based on an available tile mask indicating a first tile of the plurality of tiles is available, consume a first per-tile queue of the plurality of per-tile queues allocated to the first tile to attain geometry data associated with the first tile; and
render, to a buffer, pixel attribute data of one or more primitives at least partially visible in the first tile based on the geometry data associated with the first tile.

2. The AU of claim 1, wherein the AU further comprises:
a geometry circuitry configured to:
store the geometry data associated with the first tile to the per-tile queue of the allocated to the first tile; and
based on storing the geometry data associated with the first tile in the per-tile queue allocated to the first tile, updating the available tile mask to indicate the first tile is available.

3. The AU of claim 1, wherein the AU further comprises:
a second instance of pixel circuitry configured to:
based on the available tile mask indicating a second tile of the plurality of tiles is available, consume a second per-tile queue of the plurality of per-tile queues allocated to the second tile to attain geometry data associated with the second tile; and
render, to a buffer, pixel attribute data of one or more primitives at least partially visible in the second tile based on the geometry data associated with the second tile.

4. The AU of claim 3, wherein the second instance of pixel circuitry is configured to access the available tile mask concurrently with the first instance of pixel circuitry rendering the pixel attribute data of one or more primitives at least partially visible in the first tile.

5. The AU of claim 1, wherein the first instance of pixel circuitry is configured to:
based on completing a tile lighting stage for the first tile, accessing the available tile mask.

6. The AU of claim 5, wherein the first instance of pixel circuitry is configured to:
based on the available tile mask indicating a third tile is available, consume a third per-tile queue of the plurality of per-tile queues allocated to the third tile to attain geometry data associated with the third tile.

7. The AU of claim 1, wherein the first instance of pixel circuitry is configured to consume the first per-tile queue of the plurality of per-tile queues allocated to the first tile concurrently with a geometry circuitry performing a visibility pass that determines which primitives of the frame are at least partially visible in each tile of the plurality of tiles.

8. A method, comprising:
based on an available tile mask indicating a first tile of a plurality of tiles of a frame to be rendered is available, consuming, by a first instance of pixel circuitry, a first per-tile queue allocated to the first tile to attain geometry data associated with the first tile; and
rendering, to a buffer, pixel attribute data of one or more primitives at least partially visible in the first tile based on the geometry data associated with the first tile.

9. The method of claim 8, further comprising:
storing the geometry data associated with the first tile to the per-tile queue allocated to the first tile; and
based on storing the geometry data associated with the first tile in the per-tile queue allocated to the first tile, updating the available tile mask to indicate the first tile is available.

10. The method of claim 8, further comprising:
based on an available tile mask indicating a second tile of the plurality of tiles is available, consuming, by a second instance of pixel circuitry, a second per-tile queue allocated to the second tile to attain geometry data associated with the second tile; and
rendering, to a buffer, pixel attribute data of one or more primitives at least partially visible in the second tile based on the geometry data associated with the second tile.

11. The method of claim 10, further comprising:
accessing, by the second instance of pixel circuitry, the available tile mask concurrently with the first instance of pixel circuitry rendering the pixel attribute data of one or more primitives at least partially visible in the first tile.

12. The method of claim 8, further comprising:
based on completing a tile lighting stage for the first tile, accessing, by the first instance of pixel circuitry, the available tile mask.

13. The method of claim 12, further comprising:
based on the available tile mask indicating a third tile is available, consuming, by the first instance of pixel circuitry, a third per-tile queue allocated to the third tile to attain geometry data associated with the third tile.

14. The method of claim 8, consuming the first per-tile queue allocated to the first tile is concurrent with a geometry circuitry performing a visibility pass that determines which primitives of the frame are at least partially visible in each tile of the plurality of tiles.

15. An acceleration unit (AU), comprising:
one or more caches; and
one or more processor cores coupled to the one or more caches and configured to:
partition a frame to be rendered into a plurality of tiles;
based on an available tile mask indicating a first tile of the plurality of tiles is available, write pixel attribute data of primitives at least partially visible in the first tile to the one or more caches; and
based on the available tile mask indicating that a second tile of the plurality of tiles is available, write pixel attribute data of primitives at least partially visible in the second tile to the one or more caches.

16. The AU of claim 15, wherein the one or more processor cores are configured to write the pixel attribute data of primitives at least partially visible in the second tile concurrently with releasing the pixel attribute data of the primitives at least partially visible in the second tile from the one or more caches.

17. The AU of claim 15, wherein the one or more processor cores are configured to:
based on completing a tile lighting stage for the first tile, accessing the available tile mask.

18. The AU of claim 17, wherein the one or more processor cores are configured to:
based on the available tile mask indicating a third tile is available, write pixel attribute data of primitives at least partially visible in the third tile to the one or more caches.

19. The AU of claim 15, wherein the one or more caches include a plurality of per-tile queues each allocated to a corresponding tile of the plurality of tiles.

20. The AU of claim 15, wherein the one or more processor cores are configured to consume a per-tile queue associated with the first tile to obtain geometry data associated with the primitives at least partially visible in the first tile.
